(19) United States
(12) Patent Application Publication
(10) Pub. No.: US 2008/0091475 A1
(43) Pub. Date: Apr. 17, 2008

(54) Medication management and record access system

(76) Inventor: Anna Sottile, Key Biscayne, FL (US)

Correspondence Address: Mark D. Bowen;Stearns Weaver Miller, et al., Suite 2100, 200 East Las Olas Boulevard, Fort Lauderdale, FL, 33301, US

(21) Appl. No.: 11/974,229

(22) Filed: Oct. 12, 2007

Related U.S. Application Data
(60) Provisional application No. 60/851,226, filed on Oct. 12, 2006.

(51) Int. Cl. G06Q 10/00; G06F 17/30; G06Q 50/00; G06F 17/40

(52) U.S. Cl. 705/3

(57) ABSTRACT

A wireless prescription management and access system integrated with participating pharmacies and the user's wireless communication account improves patient compliance by alerting the user to take medications in accordance with dosage requirements by transmission of a wireless reminder signal to the user's cellular telephone or other personal wireless device. The system further functions to provide the user, as well as the attending physician, with remote on-demand access to the user's current prescription list as maintained by the user's pharmacy via a wireless link between the user's cellular phone and the pharmacy. The system is preferably integrated with patient and prescription records in a database maintained by the user's participating pharmacy to provide access to prescription records and other relevant patient information, such as allergies and emergency contact information.

### CROSS REFERENCE TO RELATED APPLICATIONS

This application claims the benefit of provisional U.S. patent application Ser. No. 60/851,226, filed Oct. 12, 2006.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to information systems for handling patient medical records, and more particularly, to a wireless medication management and records access system for providing remote wireless access to prescription records, and other patient information maintained by the patient's pharmacy. Compliance with prescribed medications is improved by sending the patient an alarm in the form of a text message or cellular telephone call to remind the patient that it is time to take one or more medications in accordance with patient's current prescription history and record, and harmful drug interactions are prevented by provision of complete prescription histories.

2. Description of Related Art

Advancements in the medical sciences have resulted in the development and use of a number of new medications. While these medications have proven remarkably successful in preserving and extending a person's life, non-compliance issues have become a major problem. The sheer number of prescriptions that a patient must be aware of has increased the information for which the patient is responsible dramatically. It has been found that on average people over the age of 55 consume 7 different prescription medications daily.

A complication experienced by people taking multiple prescription medications involves the taking of the medications in compliance according to the prescribed dosage instructions. As a result, the background art reveals developments in the field of drug compliance reminder devices. Drug compliance reminder devices currently consist of various electronic and mechanical timers and pagers. An example of a drug compliance technology is found in U.S. Pat. No. 6,294,999, issued to Yarin, which discloses a smart tray, adapted to receive prescription vials, that monitors and reports a patients compliance to third parties. Other devices known in the art comprise prescription vials wherein the cap is adapted with a rudimentary alarm that may be programmed to alert the user at regularly scheduled intervals, e.g. every 6 hours.

An additional problem associated with multiple prescriptions relates to the difficulty patients often experience when attempting to accurately identify the various prescriptions they are taking when seeing a primary care doctor or specialist. In this regard, the main problem with conventional drug compliance devices is a lack of real time interactivity from the patient, the patient's doctor and the pharmacist with regard to the patient's drug regimen and compliance.

Accordingly, it is further known in the art to employ computers, patient identification bracelets, and electronic identification methods for identifying patients and/or tracking patient medical procedures and medications. However, these devices and methods fail to provide consistent electronic information that is accessible by the patient as well as all medical professionals associated with providing patient care, diagnostics, testing, prescription and medication administration. In some cases, the patient identification is entirely or partially manual, which introduces the likelihood of error from transcription of patient identification and/or corresponding medical treatment, procedures, prescriptions, testing, and diagnosis. Also, the accessibility to patient information and identity is generally limited by the location of the computers and computer networks, which are not generally located with the patient and/or are not portable. Another problem with conventional drug compliance devices is that the devices are not wireless, hence they are not portable, and require the patient's active input to operate, or, if they are wireless, then they are only pager units that do not hold the patient's medication. A final problem with conventional drug compliance devices is that they are specialized and expensive and the cost for the device is borne by the patient/consumer. In addition, any such system must incorporate appropriate security means for ensuring that patient information is not accessed by unauthorized individuals and/or entities, in particular under the recent Health Insurance Portability and Accountability Act of 1996 (HIPAA) regulations that were intended to provide protection to a patient's medical records. Furthermore, with reduced access to medical records to ensure patient privacy rights, it has become increasingly difficult to provide adequate, consistently updated information to the appropriate health care providers, which may increase the likelihood of errors, some of which may be harmful to the patient, or even fatal.

Among the systems in the background art that utilize smart card technology are the following: U.S. Pat. No. 5,659,741, issued to Eberhart discloses a computer system and method for storage of individual medical histories on a storage device the size of a credit card; U.S. Pat. No. 5,899,998, issued to McGauley, discloses a distributed database architecture for storing medical information in a self-updating system that employs point-of-service stations disposed at medical service locations. These systems suffer from the disadvantage that access to patient information is generally limited by the location of the computers that are not universally dispersed throughout the medical community.

U.S. Pat. No. 6,961,285, issued to Niemiec et al, discloses a drug delivery management system that assists patients in taking of medication while also assisting third parties in accumulating information regarding patient medication intake. According to that system, a medication monitor may be provided with a remote communications capability, such as a capability to communicate with a remote computer. The communications path may be a wireless path, such as a cellular transmission network used with cell phones and/or other wireless handheld devices. Niemiec discloses providing physician access such that the physician can determine what medications have been prescribed to the patient. Niemiec, however, requires that the user acquire and carry a specialized medical monitor wireless device to provide access to the information.

U.S. Pat. No. 6,985,689, issued to Stoll, et al., discloses a digital prescription carrier and monitor system for storing prescription data. Prescription data for one or more medications is stored within the carrier by a physician and downloaded by a pharmacist to fill the prescriptions called for. The carrier apparatus requires the entry of a decryption key to access prescription data within the carrier to prevent unauthorized access or tampering with the prescription data. The carrier apparatus also functions as a prescription reminder to the patient and records compliance with the prescription. Stoll et al., also require a specialized monitor for use, and thus suffers from disadvantages similar to those associated with the Niemiec technology.

As a result, a need exists in the art for a medical records management and access system that is effective in increasing compliance by automatically reminding patients of dosage requirements while further being capable of providing both the patient and patient's health care provider with an updated complete prescription history record on demand. There further exists a need for such a system that is integrated with the user's pharmacy and wireless communication services provider.

### BRIEF SUMMARY OF THE INVENTION

The present invention overcomes the disadvantages present in the medical arts by providing a wireless prescription management and access system integrated with participating pharmacies and the user's wireless communication account. A system in accordance with the present invention improves patient compliance by alerting the user to take medications in accordance with dosage requirements by transmission of a wireless reminder signal to the user's cellular telephone or other personal wireless device. The system functions to increase compliance by alerting the user when it is time to take medications in accordance with dosage requirements by transmission of a wireless reminder signal to the user's cellular telephone or other personal wireless device. The system further functions to provide the user, as well as the attending physician, with remote on-demand access to the user's current prescription list as maintained by the user's pharmacy via a wireless link between the user's cellular phone and the pharmacy. As a result, the present invention further functions to avoid the issuance of prescriptions that would adversely interact with other patient prescriptions thereby preventing dangerous drug interactions. By integrating the system with the records maintained by the user's participating pharmacy the system provides wireless on-demand access to prescription records and other relevant patient information, such as allergies and emergency contact information.

Accordingly, it is an object of the present invention to provide a medical records management and access system.

Still another object of the present invention is to provide a wireless prescription management system that increases compliance by alerting the user of prescription dosage and schedule.

Another object of the present invention is to provide such a system wherein an alarm is transmitted to the user's cellular telephone or other wireless device alerting the user that the time has come to take a particular medication or combination of medications.

Yet another object of the present invention is to provide a wireless prescription management system that increases patient awareness of the various medications taken by providing wireless cellular telephone access to the patient's record of medications as maintained by the patient's pharmacy.

A further object of the present invention is to provide such a system wherein the patient's prescription record may be received in the user's cellular telephone directly from the pharmacy by on-demand wireless communication and subsequently transmitted from the user's cellular telephone to a printer, or other computer hardware, in a provider's office.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a block diagram of a medication management and access system in accordance with the present invention.

### DETAILED DESCRIPTION OF THE INVENTION

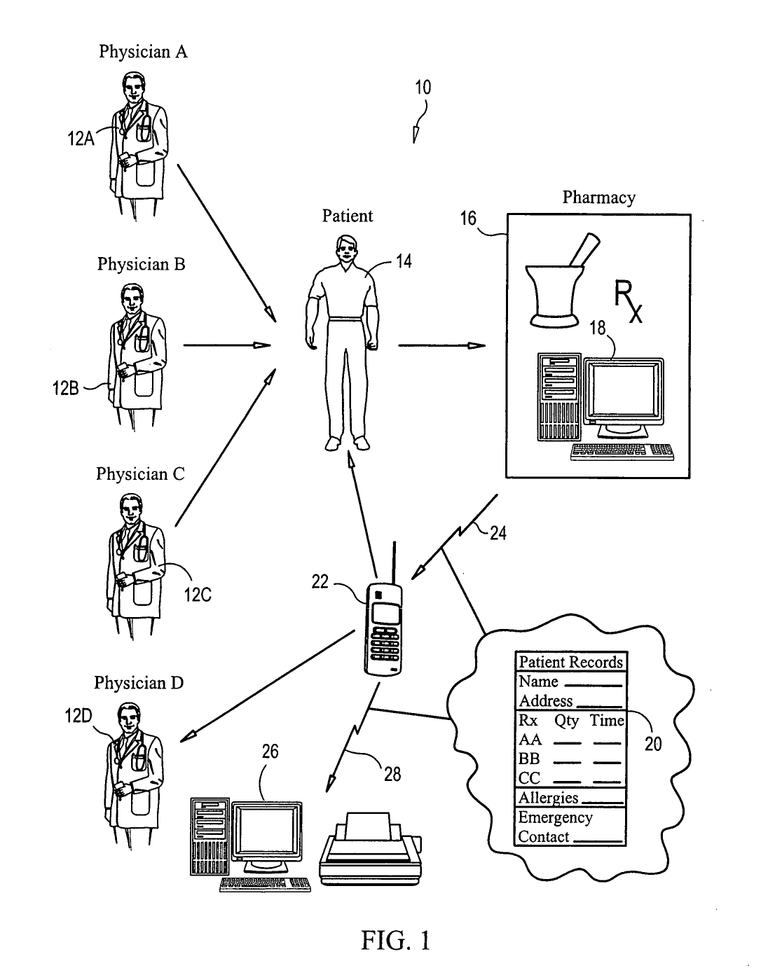

With reference now to the drawings, FIG. 1 illustrates a wireless prescription records management and access system, generally referenced as 10, in accordance with the present invention. Wireless prescription records management and access system 10 is designed to increase patient compliance with prescription medications by providing the user with wirelessly transmitted alerts timed to coincide with the user's prescribed dosage list and schedule, while further providing the user with wireless remote access to his or her prescription records. System 10 is preferably integrated with data records maintained by the user's pharmacy and further adapted for automatic communication with the user's cellular telephone or other wireless communications device as further discussed herein.

As best depicted in FIG. 1, the system functions in connection with prescriptions issued by one or more physicians, referenced as 12A, 12B, and 12C, to a patient 14. Upon presenting the prescriptions to a participating pharmacy 16, the patient's records are updated and stored in an electronic database associated with the pharmacy's computer system 18. As should be apparent, pharmacy 16 may have multiple locations and the computer system may comprise a computer network including a plurality of computer systems residing in multiple locations and capable of electronic communication and data sharing. Besides a record of prescriptions taken, it is important for a patient to have a brief personal information summary that can be provided to health care providers. Accordingly, the information maintained by computer system 18 of the present system 10 may also include information regarding the patient's team of physicians, insurance information, potential allergies, and emergency contact information. System 10 further functions to compile and format the various patient-related information into a patient record file, generally referenced as 20. The patient record file is updated automatically each time patient 14 provides the pharmacy with a new prescription issued by a physician 12A-C.

A significant aspect of a wireless prescription records management and access system in accordance with the present invention involves increasing compliance by alerting the user of prescription dosage in accordance with the schedule specified by the physician for each medication prescribed. More particularly, system 10 of the present invention automatically contacts the patient 14 by transmitting a signal or communication 24 to the user's personal wireless communications device, referenced as 22, which may typically be the user's cellular telephone, or any other electronic address specified by the user (e.g. e-mail address etc.). While communications device 22 is shown as a cellular telephone in FIG. 1 for purpose of illustration, it should be noted that any suitable personal device capable of receiving wireless communications is considered within the scope of the present invention. Transmission 24 may comprise a text message that informs the user to take a particular medication at the appropriate time. In the alternative, transmission 24 may comprise a recorded voice message that identifies: (a) the medication to be taken; (b) the dosage; and (c) the scheduled time for taking the medication. In still other alternate embodiments, transmission 24 may comprise a text message, and/or may alert the user by activating a special dedicated ring tone on the user's cellular telephone. Finally, in the event that the user does not immediately receive transmission 24 the system contemplates leaving a message by voice mail. In addition, transmission 24 may further remind the user of any requirements associated with the medication, i.e. that the medication should be taken with food. This reminder alert is preferably timed for transmission 5-10 minutes prior to the time that the user is scheduled to take the medication. The timing of the transmission maximizes compliance by allowing the user sufficient time from receipt of the transmission to access and take the medication, while not providing so much time in between transmission and the scheduled taking time such that the user would likely forget. In addition, depending on the number of medications prescribed and scheduling the transmission may alert the user to schedule information for one or more medications.

A further significant aspect of the present invention provides the user, as well as the attending physician, with remote on-demand access to the patient record information 20 via a wireless link between the user's cellular phone 22 and the pharmacy computer system 18. According to this embodiment, when patient 14 sees a new physician, referenced as physician 12D, system 10 allows patient 14 to remotely access his patient record information 20 from computer system 18 maintained by the participating pharmacy 16 by wireless communication with computer system 18. According to this embodiment, patient 14 dials into the telephone access portion of system 10 to request that his patient record 20 be transmitted to his cellular telephone 22. The telephone access portion of system 10 preferably comprises a menu driven system navigated by entering touch-tones in response to voice prompts as is known in the telecommunications art.

In addition, the system incorporates appropriate security means for ensuring that patient information is not accessed by unauthorized third parties as required under the HIPAA regulations. In order to prevent access by unauthorized persons to the patient's medical history information, the present invention limits access to the information by PIN or password, and further protects any transmitted data via data encryption.

Patient 14 is thus able to request that his patient record be transmitted to from the pharmacy directly to his cellular telephone 22 when visiting a new physician, such as physician 12D, so as to be able to provide the physician with current record 20 of medical information, specifically including a prescription log as set forth above. A further aspect of the present invention involves transmitting patient record 20 from the patient's cellular telephone 22 to the physician's computer system 26 via a wireless transmission 28. According to this embodiment, patient record 20 is transmitted using infrared data transmission technology. More particularly, cellular telephone 22 is adapted with an infrared transmitter and the computer system 26 maintained in the office of physician 12D is adapted with an infrared receiver, which combine to allow for the transfer of the patient record data. In other embodiments, the information may be transmitted to any address specified by the user, such as an e-mail address.

In an alternate embodiment, the system contemplates functionality wherein confidentiality functions are bypassed such that patient record 20 may be obtained in situations wherein the patient is unconscious. In this embodiment, an attending physician may confirm the patient's status to pharmacy personnel such that the records may be transmitted. In still another alternate embodiment, a terminally ill patient may elect to permanently bypass confidentiality functions such that the records are readily available in case of an emergency.

As should now be apparent, the present invention improves compliance by automatically transmitting reminder alerts to the patient periodically throughout the day to insure that the patient is aware of dosage requirements, scheduling, and related medicine requirements. The present invention further provides the user with 24 hour, on-demand access to his or her prescription information, and further facilitates providing the information to healthcare providers caring for the user.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A wireless prescription management and records access system for improving prescription compliance and care by automatically transmitting periodic wireless communications to the patient's cellular telephone or other electronic communication device to remind the patient to take medications in accordance with dosage compliance requirements, said system comprising:
a pharmacy computer system having a database for electronically storing patient medical records, said patient medical records including prescription records, said prescription records including prescription name, dosage, and dosage compliance and scheduling information, for at least one patient;
said computer system adapted for wireless communication;
said computer system including database management software including means for automatically generating periodic wireless reminder transmissions to the patient's cellular telephone;
said wireless reminder transmissions being timed to coincide with said dosage compliance schedules to alert the patient of dosage compliance requirements;
said computer system further adapted with means for providing remote on-demand electronic access to patient medical records by electronically transmitting selected patient medical records to a cellular telephone or other patient specified electronic address in response to receiving a wirelessly transmitted request and password.

2. A wireless prescription management and records access system according to claim 1, wherein said wireless reminder transmissions comprise a pre-recorded voice message reminding the user of compliance information including the prescription name, and dosage compliance information.

3. A wireless prescription management and records access system according to claim 1, wherein said wireless reminder transmissions comprise a text message reminding the user of compliance information including the prescription name, and dosage compliance information.

4. A wireless prescription management and records access system for improving prescription compliance and care by automatically transmitting periodic wireless communications to the patient's cellular telephone or other electronic communication device to remind the patient to take medications in accordance with dosage compliance requirements, said system comprising:
a pharmacy computer system having a database for electronically storing patient medical records including prescription records, said prescription records including prescription name, dosage, and dosage compliance information, for at least one patient;
said computer system adapted for wireless communication;
said computer system including database management software including means for automatically generating periodic wireless reminder transmissions directed to a wireless enabled portable electronic device at an address specified by the patient;
said wireless reminder transmissions being sent prior to the predetermined time that the patient is scheduled to take a prescription dose to alert the patient of dosage compliance requirements by identifying the prescription name, the appropriate dosage, and the appropriate time for taking of medication by the patient;
said computer system further adapted with means for providing remote on-demand electronic access to patient prescription records stored on said pharmacy computer database by receiving wireless transmission of a patient specific identifier and password and electronically transmitting selected patient prescription records to a wireless enabled portable electronic device in response thereto.

5. A wireless prescription management and records access system according to claim 4, wherein said wireless reminder transmissions comprise pre-recorded voice messages reminding the user of compliance information including the prescription name, and dosage compliance information.

6. A wireless prescription management and records access system according to claim 4, wherein said wireless reminder transmissions comprise text messages reminding the user of compliance information including the prescription name, and dosage compliance information.

7. A wireless prescription management and records access system according to claim 4, wherein said means for providing remote on-demand electronic access to patient prescription records stored on said pharmacy computer database includes establishing remote electronic wireless communication with said computer system, obtaining at least one patient specific identifier, obtaining at least one patient specific password, accessing patient prescription records upon receipt of said at least one patient specific identifier and password, and transmitting patient prescription records to an electronic address specified by the patient.

8. A wireless prescription management and records access system according to claim 4, wherein said wireless enabled personal electronic device is adapted with an infrared data transmitter, and further including a physician computer adapted with an infrared data receiver to allow transmission of patient medical records from the personal electronic device to said physician computer system.
